(19) United States
(12) Patent Application Publication
(10) Pub. No.: US 2011/0293234 A1
(43) Pub. Date: Dec. 1, 2011

(54) INTERNAL SLACK STORAGE OF CABLE ON A REMOVABLE MOUNTING SURFACE

(75) Inventors: Lawrence Srutkowski, Greenville, SC (US); Wilfred J. Courchaine, Moore, SC (US); Roger Vaughn, Greer, SC (US)

(73) Assignee: AFL TELECOMMUNICATIONS LLC, Spartanburg, SC (US)

(21) Appl. No.: 13/128,541

(22) PCT Filed: Feb. 2, 2011
(86) PCT No.: PCT/US11/23462

§ 371 Date: May 10, 2011

Related U.S. Application Data
(60) Provisional application No. 61/300,471, filed on Feb. 2, 2010.

(51) Int. Cl. G02B 6/00

(52) U.S. Cl. 385/135

(57) ABSTRACT

A cable storage unit is provided having an enclosure body having a first casing and a second casing which are moveably attached at conjoining sides for opening and closing the enclosure body, where a main storage area is provided within the enclosure body; a removable mounting plate which is removably mounted onto the first casing and mounted within the main storage area, the removable mounting plate having a front surface and a back surface, and, upon mounting the removable mounting plate onto the first casing, a cable storage area is formed between the back surface of the removable mounting plate and an inside surface of the first casing; and at least one cable management unit coupled to the back surface of the removable mounting plate and which is configured to secure at least one coil of cable to the removable mounting plate within the cable storage area.

### CROSS-REFERENCE TO RELATED APPLICATIONS

This application claims priority from U.S. Provisional Application No. 61/300,471, filed on Feb. 2, 2010, the disclosure of which is incorporated herein by reference in its entirety.

### BACKGROUND

1. Field

The present invention generally relates to a slack storage unit, and more particularly, to an internal slack storage unit which stores a cable on a removable mounting surface which can be easily removed from the slack storage unit.

2. Description of the Related Art

Most fiber optic enclosures allow for a minimal amount of slack storage within an enclosure body. More often, the jacketed cable must be stored externally on a spool or ring mechanism. When slack storage is permitted within the enclosure, the cable must first be shed of its protective jacket before it can be spooled. The common practice is to place a series of clips or ring features in place to guide the cable around a storage location. These features are often placed on top of the interface surface within the enclosure with everything within on a single layer. When these features are not compatible with the commonly used methods, they are not capable of storing a large length of cable.

Alternately, a large amount of slack cable may be stored externally to the enclosure. When this is done, there is often a large coil or horseshoe shaped device placed adjacent to or behind the enclosure. While such devices do contain the fiber cable, they offer only minimal protection to the cable since the cable is exposed to the environment.

In addition, in a Multiple Dwelling Unit (MDU) environment, the owners/operators are often concerned with the aesthetics of the exterior of their structures. In the current case of an externally storing a slack loop/coil, the fiber cable is readily visible to observers.

### SUMMARY

Exemplary embodiments of the general inventive concept invention may overcome the above disadvantages as well as other disadvantages not described above.

According to an exemplary embodiment, there is provided cable storage unit, including an enclosure body having a first casing and a second casing which are moveably attached at conjoining sides for opening and closing the enclosure body, wherein a main storage area is provided within the enclosure body; a removable mounting plate which is removably mounted onto the first casing and mounted within the main storage area, the removable mounting plate comprising a front surface and a back surface, wherein, upon mounting the removable mounting plate onto the first casing, a cable storage area is formed between the back surface of the removable mounting plate and an inside surface of the first casing; and at least one cable management unit coupled to the back surface of the removable mounting plate and which is configured to secure at least one coil of cable to the removable mounting plate within the cable storage area.

The front surface of the mounting plate may be configured to couple to at least one fiber optic interface component.

Each cable management unit may include at least one storage bracket which secures the coil or coils of cable to the removable mounting plate.

A mounting unit is coupled to the first casing, wherein the removable mounting plate removably couples or attaches to the mounting unit.

The removable mounting plate may include a mounting slot which extends through the removable mounting plate at a first end portion of the removable mounting plate, and the mounting unit is a hanger plate which is disposed at a first end portion of the first casing corresponding to a location of the first end portion of the removable mounting plate, wherein the mounting slot is configured to receive the hanger plate for mounting the removable mounting plate to the first casing.

The removable mounting plate may include a first locking unit disposed at a second end portion of the removable mounting plate opposite to the first end portion of the removable mounting plate, and the first casing may include a second locking unit configured to removably couple to the first locking unit for securing the removable mounting plate to the first casing.

The first locking unit may be a locking pin which extends through the removable mounting plate, and the second locking unit may be a locking pin hole.

### BRIEF DESCRIPTION OF THE DRAWINGS

The above and other aspects of the present invention will become more apparent from the following description of exemplary embodiments, taken in conjunction with the accompanying drawings of which:

FIG. 1 illustrates an angled view of a slack storage unit according to an exemplary embodiment;

FIG. 2 illustrates another angled view of a slack storage unit according to an exemplary embodiment; and

FIG. 3 illustrates another angled view of a slack storage unit according to an exemplary embodiment.

FIG. 4 illustrates another angled view of a slack storage unit according to an exemplary embodiment.

FIG. 5 illustrates another angled view of a slack storage unit according to an exemplary embodiment.

FIG. 6 illustrates another angled view of a slack storage unit according to an exemplary embodiment.

FIG. 7 illustrates another angled view of a slack storage unit according to an exemplary embodiment.

Throughout the drawings, the same drawing reference numerals will be understood to refer to the same elements, features, and structures.

### DETAILED DESCRIPTION OF THE EXEMPLARY EMBODIMENTS

The matters defined in the description such as a detailed construction and elements are provided to assist in a comprehensive understanding of the embodiment of the invention and are merely exemplary. Accordingly, those of ordinary skill in the art will recognize that various changes and modifications of the embodiment described herein can be made without departing from the scope and spirit of the general inventive concept. Also, descriptions of well-known functions and constructions are omitted for clarity and conciseness. In the following description, like drawing reference numerals are used for the like elements, even in different drawings.

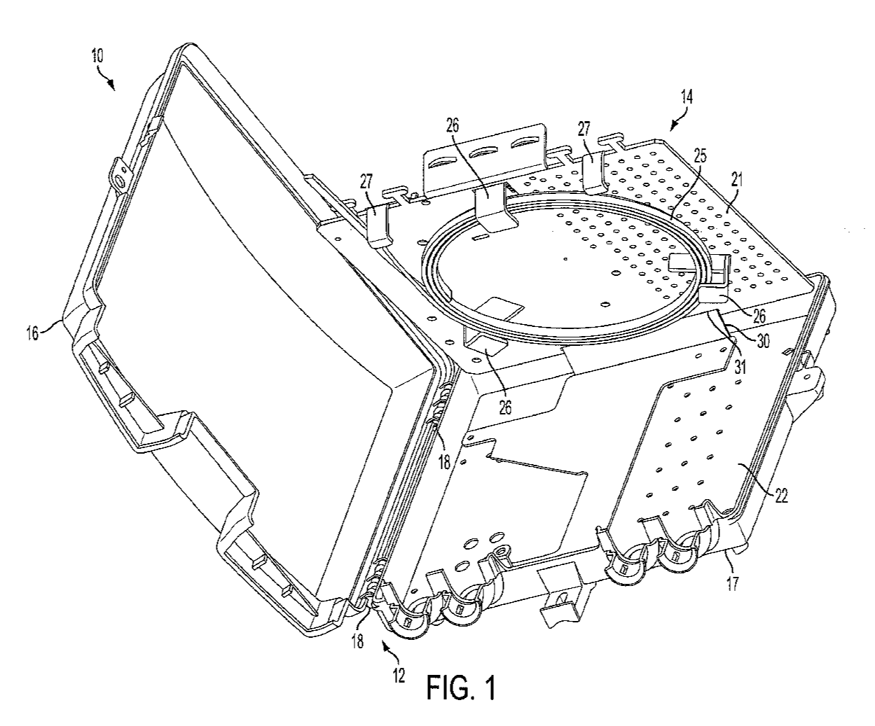

FIG. 1 illustrates an angled view of a slack storage unit 10 according to an exemplary embodiment. The slack storage unit 10 is provided with an enclosure body 12 and a removable mounting plate 14. In this embodiment a multi-plate system is used to mount the removable mounting plate 14 within the enclosure body 12. One or more cables are stored as one or more coils attached to the back side of the removable mounting plate 14, and various other components are mounted to the front and/or back side of the removable mounting plate 14.

The enclosure body 12 includes a front casing 16 and a back casing 17 hingedly attached to each other by hinges 18 so that the front casing 16 and/or back casing 17 can be open/closed. The front and back casings 16 and 17 have recessed area which are used to form a main storage area when the free ends of the front and back casings 16 and 17 are latched together. When the free ends of the front casing 16 and the back casing 17 are latched together, a closed body is formed which protects various components and cables provided therein. Although this particular exemplary embodiment shows the casings 16 and 17 being connected by hinges 18, other means of attaching the casings may be used, and should not be limited to hinges.

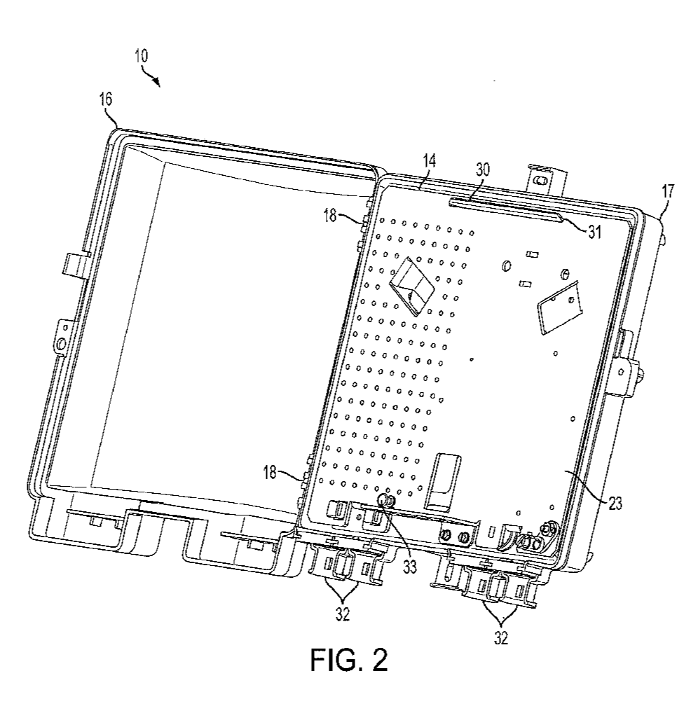

The removable mounting plate 14 is removably mounted within the main storage area of the enclosure body 12 with a back surface 21 of the mounting plate 14 facing an inside surface 22 of the back casing 17. The removable mounting plate 14 is used for the placement of various fiber optic interface components (e.g., media converters, splice enclosures, splitters, etc.) (not shown) on its front surface 23, shown in FIG. 2. The removable mounting plate 14 also has features added to the back surface 21 to allow for the storage of either or both a jacketed and a unjacketed fiber optic cable 25.

Although the exemplary embodiments describe storing fiber optic cables and fiber optic components, the removable mounting plate 14 is not limited to the mounting of and storing fiber optic components and fiber optic cables, and may store any other type of cable, such as a Category 3 (CAT3) cable, a Category 5 (CAT5) cable, a coaxial cable, copper cables, or the like, and any interface components corresponding thereto.

In addition, the back surface 21 of the removable mounting plate 14 may also be used for mounting components thereon. For example, splice trays, fiber optic connector adapters, and/or grounding studs may be mounted on the back surface 21 of the removable mounting plate 14.

FIG. 1 shows features added to the back surface 21 to allow for the storage the fiber optic cable 25. In particular, FIG. 1 shows a plurality of storage brackets 26 which form a cable management loop and which hold a coil or spool of cable 25 in place for storing. Accordingly, when the removable mounting plate 14 is mounted in the enclosure body 12, the slack cable 25 is stored in an cable storage area between the inside surface 22 of the back casing 17 and the back surface 21 of the removable mounting plate 14.

Additional storage brackets 26 may be added to form another cable management loop (not shown) such that the removable mounting plate 14 includes two cable management loops. For example, one cable management loop could be used to store an inbound cable, while the second cable management loop could be used to store an outbound cable. Accordingly, one cable management loop could be located inside the periphery of the other cable management loop. Or, on a large enough removable mounting plate 14, the cable management loops could be arranged side-by-side. Additional cable management loops may also be provided.

The storage brackets 26 may also be used to support the removable mounting plate 14 on the inside surface 22 of the back casing 17 when the removable mounting plate 14 is in its final, fully mounted position. Support units 27 may also be used to support the removable mounting plate 14 on the inside surface 22 of the back casing 17.

Other types of storage units may be used instead of storage brackets 26 to form one or more cable management loops, and thus should not be limited thereto. For example, clips, latches, hooks, channel/s, tube/s, compartments or other types of holders may be used to hold the coil of cable 25 onto the back surface 21 of the removable mounting plate 14. The storage unit may be formed as a single-piece that has a coil-shaped perimeter with a hook-like body that either hooks inwards or outwards relative to its center. Furthermore, the storage unit/units and the removable mounting plate 14 may be formed as a one-piece integral construction, or the storage unit/units may be coupled to the removable mounting plate 14 by a faster.

Due to the design of the structure of the multi-plate system, extended lengths of jacketed cable may be stored on the removable mounting plate 14 within the enclosure body 12. The removable mounting plate 14 design also allows for strength-member stiffened drop cables to be safely stored in extended lengths (e.g., 6 meters or greater). The removable mounting plate 14 separates the cable slack cable storage from the equipment side. For example, as noted above, various fiber optic interface components and equipment (e.g., media converters, splice enclosures, splitters, etc.) can be disposed on the front surface 23 of the removable mounting plate 14, while the slack cable 25 is stored on the back surface 21 of the removable mounting plate 14. The removable mounting plate 14 can also allow for grounding of cable, strength members, and/or other equipment.

The removable mounting plate 14 is removably mounted within the enclosure body 12. In order to removably mount the removable mounting plate 14 within the enclosure body 12, there is provided a mounting mechanism which is configured to allow the removable mounting plate 14 to be mounted/removed. In this exemplary embodiment, a hanger plate 30 is mounted directly to an inside portion of the back casing 17 near one of the inside walls of the back casing 17. The removable mounting plate 14 is provided with a slot 31 near one end and a locking unit (to be described below) at an opposite end. The slot 31 extends through the removable mounting plate 14 and is configured to receive the hanger plate 30 therethrough. In particular, during mounting of the removable mounting plate 14, the hanger plate 30 is slid through the slot 31, and the opposite end of the removable mounting plate 14 is lowered into position until the removable mounting plate 14 rests in its fully mounted position.

FIG. 2 shows the removable mounting plate 14 in a fully mounted position within the enclosure body 12. The front face 23 of the removable mounting plate 14 is configured to receive various fiber optic interface components and equipment (e.g., media converters, splice enclosures, splitters, etc.) (not shown) which are coupled thereto. The back casing 17 also may include a number of cable ports 32 for receiving cables (e.g., fiber optic cables, CAT3 cables, CAT5 cables, coaxial cables, etc.) to be coupled to the enclosure body 12 and components therein. The slack cable 25 (not shown) is stored in an area underneath the removable mounting plate 14.

A portion of the hanger plate 30 extends through the slot 31 of the removable mounting plate 14, and a lip of the hanger plate 30 may be curled or angled upward (i.e., away from a center portion of the back casing 17) to further secure the removable mounting plate 14 in place. That is, the hanger plate 30 may have a half-hook shape or a half-hook shaped portion. A locking mechanism, such as a push-pull locking pin 33, is provided at an opposite end of the removable mounting plate 14 and secures the opposite end of the removable mounting plate 14 to the back casing 17 (to be described below).

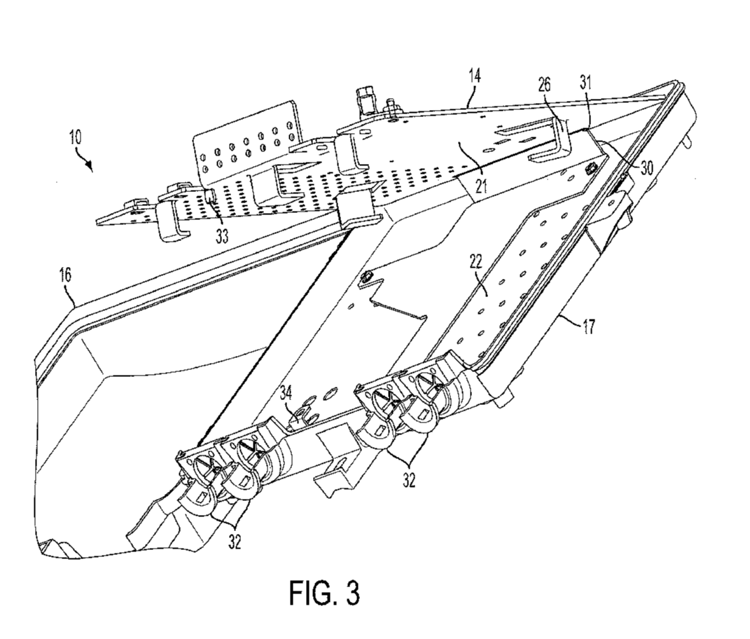

FIG. 3 shows the removable mounting plate 14 in a semi-secured position. From the semi-secured position shown, the plate could either be lifted out of the box and would allow a technician to bring the stored slack cable 25 and all the components with it, or be lowered into the fully secured position shown in FIG. 2 by lowering the opposite end of the removable mounting plate 14 into position. The locking pin 33 extends through the removable mounting plate 14 and is received by a locking pin hole 34 that is disposed on the inside surface 22 of the back casing 17 for securing the removable mounting plate 14 in place. Other types of locking mechanisms could be used instead of the locking pin 33 and locking pin hole 34. For example, the locking pin 33 could be replaced with a quarter turn fastener or a screw, and the locking pin hole 34 could be replaced with an acceptable coupler configured for the corresponding locking part of the removable mounting plate 14. Multiple locking mechanisms may also be used.

Although a hanger plate 30 and slot 32 are used to removably mount the removable mounting plate 14 onto the enclosure body 12, other types of mounting mechanisms may be used.

For example, a hinging mechanism may be used where a hinging part on the removable mounting plate 14 and another hinging part on the back casing 17 are configured to be coupled together and later decoupled. The hinging part on the back casing 17 may be located on any one of the side walls of the back casing 17, or on a plate which extends from the inside surface of the back casing (e.g., similar to the hanger plate 30). When hinging the removable mounting plate 14 on one of the side walls of the back casing 17, it may be preferred to hinge on the side adjacent to the cable ports 32, but the placement of the hinging parts are not limited thereto and may vary according to various design considerations.

Alternatively, the removable mounting plate 14 could be rigidly mounted directly to the back casing 17.

In addition, the slack storage unit 10 may include more than one removable mounting plate 14 mounted within enclosure body 12. For example, multiple removable mounting plates 14 could be stacked on top of each other or could be arranged side-by-side for a larger enclosure body 12. The same means for mounting a single removable mounting plate 14 to the enclosure body 12 may be applied for mounting multiple removable mounting plates 14.

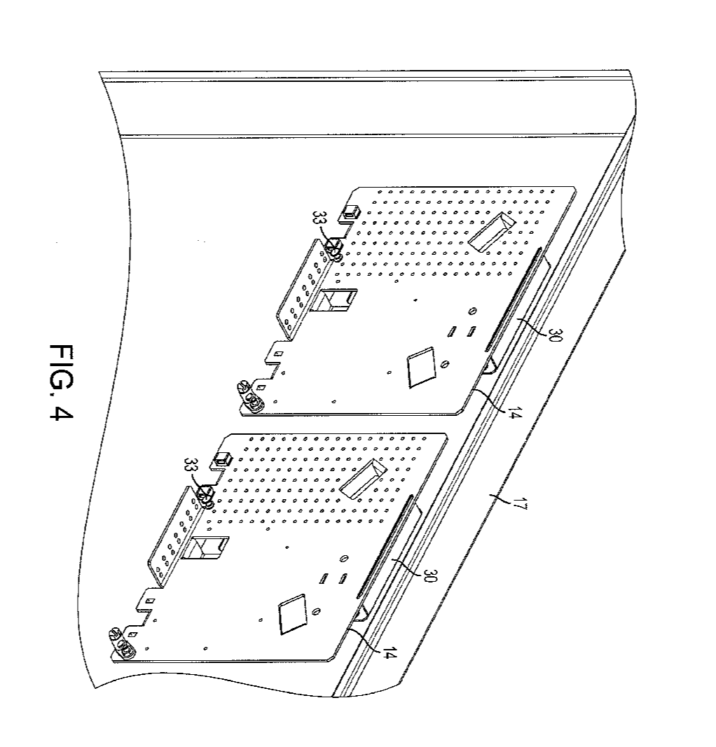

FIG. 4 shows the mounting of two removable mounting plates 14 in a side-by-side configuration where each removable mounting plate 14 is disposed on a separate hanger plate 30. The enclosure body 12 houses both removable mounting plates 14.

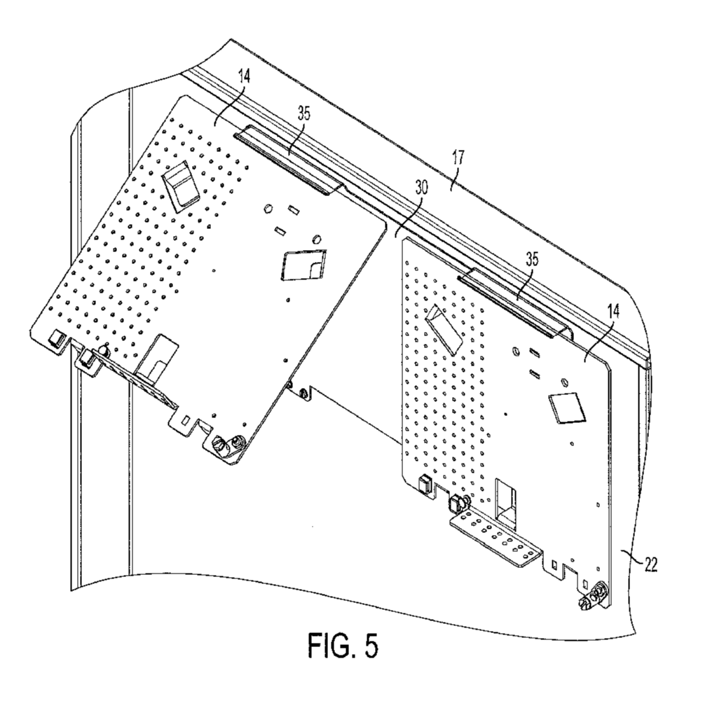

FIG. 5 shows the mounting of two removable mounting plates 14 in a side-by-side configuration, but held by one hanger plate 30 that has two hanger bracket portions 35 and is mounted to the inside surface 22 of the back casing 17.

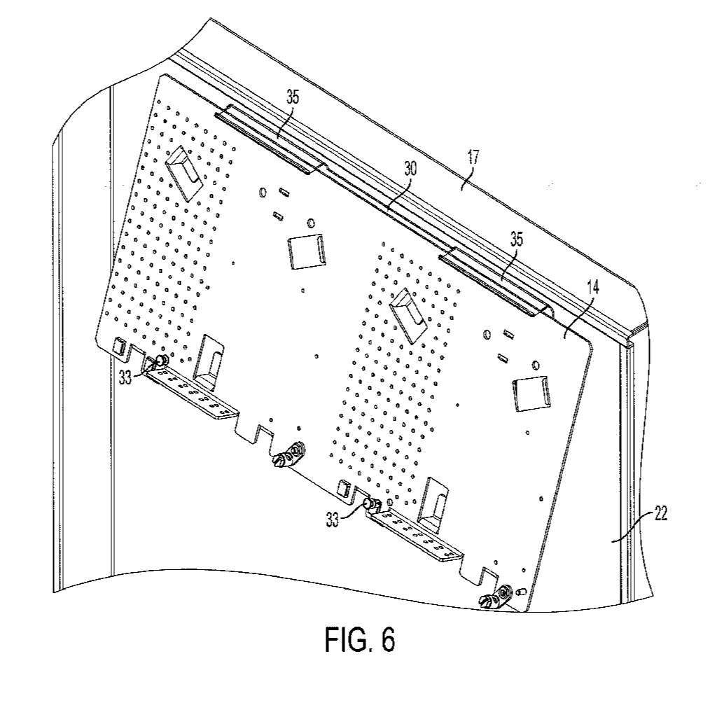

FIG. 6 shows the mounting of a single removable mounting plate 14 having two slack storage sections in a side-by-side configuration. In particular, each slack storage section of the removable mounting plate 14 in provided with at least one cable management loop disposed on the back surface 21 (not shown) to allow for the storage of multiple cables 25.

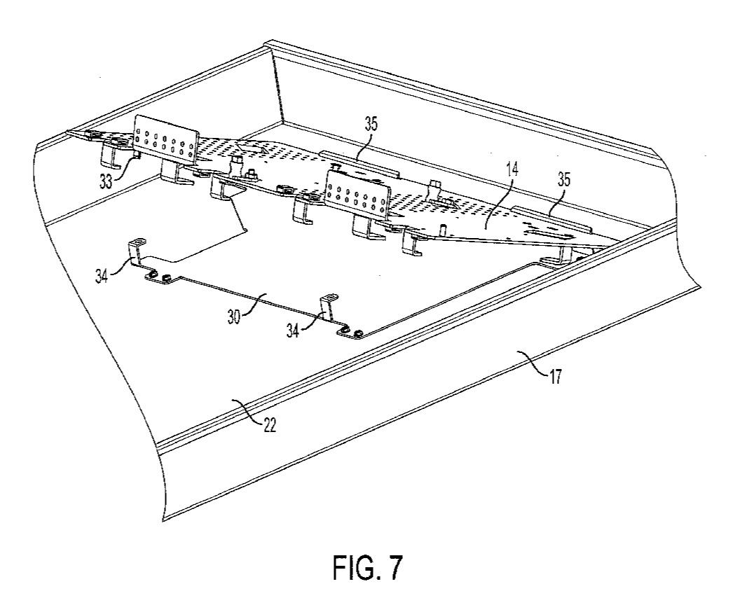

FIG. 7 shows another view of the exemplary embodiment illustrated in FIG. 6.

By allowing the jacketed cable to be stored within an enclosure body 12 on the removable mounting plate 14, the process of installing and configuring the optical devices within the enclosure is simplified. The slack cable 25 and other various components can be removed along with the removal of the removable mounting plate 14. The installer or technician may then work on the device(s) or components(s) in a more accessible manner than if the removable mounting plate 14 and slack cable 25 were still within the enclosure body 12.

The separation of cable 25 storage from other components also allows a company to use a separate technician from the installer. Since the installer only needs to store the cable, this can be done prior to connecting the components, which can be done by a separate technician. In the interim time between the installing of the cable and actual servicing and connecting of components, all of the slack cable is safely and securely stored within the enclosure body 12.

By storing the jacketed cable internally, rather than externally, the aesthetic impact of the enclosure body 12 is lessened. The enclosure body 12 provides both an extra protected casing over the cable as well as a method for hiding the necessary slack cable 25 from observation. This is especially important in Multiple Dwelling Unit (MDU) environments where owners/operators often prefer to maintain the aesthetic quality of the exterior of their structures. Since the slack storage unit 10 allows for extended lengths of cable to be stored within, the use of pre-connectorized cable is simplified. Rather than requiring the installer to estimate the length of cable necessary to reach the panel within a rather narrow margin of error, the extra slack cable 25 can be stored on the removable mounting plate 14 within the enclosure body 12. This allows for installers to work off of pre-determined lengths without the need to worry about the extra cable length.

Although the exemplary embodiments described above are directed to fiber optic cables, this is merely exemplary and the general inventive concept should not be limited thereto, and could be used with wired cables (e.g., coaxial cables) and corresponding wired cable interface components and equipment.

What is claimed is:

1. A cable storage unit comprising:
an enclosure body having a first casing and a second casing which are moveably attached at conjoining sides for opening and closing the enclosure body, wherein a main storage area is provided within the enclosure body;
a removable mounting plate which is removably mounted onto the first casing and mounted within the main storage area, the removable mounting plate comprising a front surface and a back surface, wherein, upon mounting the removable mounting plate onto the first casing, a cable storage area is formed between the back surface of the removable mounting plate and an inside surface of the first casing; and
at least one cable management unit coupled to the back surface of the removable mounting plate and which is configured to secure at least one coil of cable to the removable mounting plate within the cable storage area.

2. The cable storage unit of claim 1, wherein the front surface of the mounting plate is configured to couple to at least one interface component.

3. The cable storage unit of claim 1, wherein the at least one cable management unit includes a plurality of storage brackets which secure the at least one coil of cable to the removable mounting plate.

4. The cable storage unit of claim 1, further comprising a mounting unit coupled to the first casing, wherein the removable mounting plate removably attaches to the mounting unit.

5. The cable storage unit of claim 4, wherein the removable mounting plate includes a mounting slot which extends through the removable mounting plate at a first end portion of the removable mounting plate, and
the mounting unit is a hanger plate which is disposed at a first end portion of the first casing corresponding to a location of the first end portion of the removable mounting plate,
wherein the mounting slot is configured to receive the hanger plate for mounting the removable mounting plate to the first casing.

6. The cable storage unit of claim 5, wherein the removable mounting plate includes a first locking unit disposed at a second end portion of the removable mounting plate opposite to the first end portion of the removable mounting plate, and
the first casing includes a second locking unit configured to removably couple to the first locking unit for securing the removable mounting plate to the first casing.

7. The cable storage unit of claim 6, wherein the first locking unit is a locking pin which extends through the removable mounting plate, and
the second locking unit is a locking pin hole.

8. The cable storage unit of claim 1, further comprising a mounting unit coupled to a first end portion of the first casing, wherein the removable mounting plate removably couples to the mounting unit.

9. The cable storage unit of claim 8, wherein the first casing includes a first locking unit disposed at a second end portion of the first casing opposite to the first end portion of the first casing, and
the removable mounting plate includes a second locking unit configured to removably couple to the first locking unit for securing the removable mounting plate to the first casing.

10. The cable storage unit of claim 1, further comprising another removable mounting plate which is removably mounted onto the first casing and mounted within the main storage area, the other removable mounting plate comprising a front surface and a back surface, wherein, upon mounting the other removable mounting plate onto the first casing, another cable storage area is formed.

11. The cable storage unit of claim 10, wherein the other removable mounting plate comprises at least one of the cable management units which is coupled to the back surface of the other removable mounting plate and which is configured to secure at least one of the coils of cable to the other removable mounting plate within the other cable storage area.
